(19) United States
(12) Patent Application Publication
(10) Pub. No.: US 2025/0235816 A1
(43) Pub. Date: Jul. 24, 2025

(54) PETROLEUM GAS (LPG) RECOVERY FROM GAS STREAMS

(71) Applicant: BORNA MEMBRANE SOLUTION INC., Toronto (CA)

(72) Inventors: Seyed Ali GHADIMI, Tehran (IR); Seyed Behrouz SADATNIA, Tehran (IR); Behrouz SALIMI BENI, North York (CA); Behnam SALIMI BENI, Shahrekord (IR); Sam SALIMI BENI, North York (CA); Danial SALIMI, Shahrekord (IR)

(73) Assignee: BORNA MEMBRANE SOLUTION INC., Toronto, ON (CA)

(21) Appl. No.: 18/700,727

(22) PCT Filed: May 15, 2023
(86) PCT No.: PCT/IB2023/054971

§ 371 Date: Apr. 12, 2024

(51) Int. Cl. B01D 53/22; C10L 3/12

(52) U.S. Cl. CPC B01D 53/226; B01D 53/228; B01D 53/229; C10L 3/12; B01D 2256/24; B01D 2257/7022; C10L 2290/10; C10L 2290/46; C10L 2290/543; C10L 2290/548

(57) ABSTRACT

A process for recovery of C₃⁺ form gas streams is disclosed. The process includes dividing a feed gas into a first C₃⁺-rich stream with a higher content of C₃⁺ and a first C₁-C₂-rich stream in a first membrane module, extracting remaining C₃⁺ content in the first C₁-C₂-rich stream in a second membrane module and feeding the extracted C₃⁺ content to the first membrane module, separating a separator-liquid C₃⁺-rich stream with a higher content of C₃⁺ than the first C₃⁺-rich stream from the first C₃⁺-rich stream in a separator, forming a bottoms C₃⁺-rich stream with a higher content of C₃⁺ than the separator-liquid C₃⁺-rich stream in a distillation column and an associated reboiler using thermal energy of the feed gas, and increasing C₃⁺ content of the bottoms C₃⁺-rich stream by recovering C₃⁺ content remaining in vapor phases of the separator and distillation column using a third membrane module.

### TECHNICAL FIELD

The present application generally relates to recovery of liquefied petroleum gas (LPG) from a stream containing C₁, C₂ and C₃⁺ hydrocarbons, and particularly, to a low-energy-consuming process for recovery of LPG with an ultralow concentration of C₁ and C₂ from a gas stream.

### BACKGROUND

Liquefied petroleum gas (LPG) is a byproduct of natural gas and oil extraction, and crude oil refining. LPG contains C₃, C₄ and C₃⁺ hydrocarbons and is used at the household level, as feedstock in petrochemical applications, and other industrial uses. Many processes have been developed for LPG recovery from gas streams. For example, M. Yadav et al. disclosed a patented process with U.S. Pat. No. 8,618,344 B2 for enhanced recovery of propylene and LPG from fuel gas produced in Fluid catalytic cracking unit by contacting a heavier hydrocarbon feed with FCC catalyst. In an exemplary process, C₄ and lighter components from unstabilized naphtha are first stripped off in a separate column to obtain a liquid fraction almost free from propylene (<0.1 mol %) and other LPG components. Such a stripped liquid fraction is used in an absorber to absorb higher amounts of propylene and LPG from fuel gas, leading to improved recovery of propylene. However, most of these processes are costly and highly energy intensive. Watler also disclosed a patented process with U.S. Pat. No. 4,857,078 for separating ethane and other higher hydrocarbons from a natural or produced gas stream, having methane as its major constituent using rubbery membranes. Lokhandwala et al. in another patented process with U.S. Pat. No. 6,350,371 B1 introduced an improved membrane based process and process train for catalytic reforming of hydrocarbons. The introduced process provides improved recovery of hydrogen and LPG, and reduces the amount of gas sent to the fuel line. Minhas et al. disclosed a patented process with U.S. Pat. No. 7,799,964 B2 for LPG recovery from various streams using a multiple membrane recovery process producing hydrogen stream at high yield and high purity and a C₃⁺ LPG stream at high yield with low energy expenditure.

However, there is still a need for recovery of almost pure LPG from sources containing C₃⁺ hydrocarbons. Moreover, there is a need for a cost-effective and more lower-energy-consuming process for recovery of LPG from a source containing C₃⁺ hydrocarbons. Also, there is a need for a process for recovery of LPG with a desirable purity of LPG product.

### SUMMARY

This summary is intended to provide an overview of the subject matter of this patent, and is not intended to identify essential elements or key elements of the subject matter, nor is it intended to be used to determine the scope of the claimed embodiments. The proper scope of this patent may be ascertained from the claims set forth below in view of the detailed description below and the drawings.

In one general aspect, the present disclosure is directed to a process for recovery of C₃⁺ hydrocarbons form gas streams containing C₁, C₂ and C₃⁺. The process may include compressing a feed gas containing C₁, C₂ and C₃⁺ to a pressure in a range of 12 bar to 18 bar, adjusting a temperature of the compressed feed gas to a temperature in a range of 25° C. to 35° C., passing the compressed feed gas through a first membrane module, where the feed gas may be separated into a permeate stream comprising the first C₃⁺-rich stream with a higher content of C₃⁺ than the feed gas and a retentate stream comprising a first C₁- and C₂-rich stream, extracting a remaining amount of C₃⁺ in the first C₁- and C₂-rich stream by passing the first C₁- and C₂-rich stream through a second membrane module, where a second C₃⁺-rich stream may be generated, and recycling the second C₃⁺-rich stream to the feed gas line, compressing the first C₃⁺-rich stream to a pressure in a range of 12 bar to 18 bar, forming a two-phase stream by cooling the compressed first C₃⁺-rich stream to a temperature in a range of 25° C. to 35° C., separating the two-phase stream to a separator-liquid C₃⁺-rich stream and a vapor phase in a separator unit, and forming a bottoms C₃⁺-rich stream with a higher content of C₃⁺ than the separator-liquid C₃⁺-rich stream by removing volatile compounds from the separator-liquid C₃⁺-rich stream in a distillation column.

In an exemplary embodiment, passing the compressed feed gas through the first membrane module may include feeding the compressed feed gas to the first membrane module, retrieving the permeate stream comprising the first C₃⁺-rich stream from the first membrane module, and retrieving the retentate stream comprising the first C₁- and C₂-rich stream from the first membrane module. In an exemplary embodiment, the first C₁- and C₂-rich stream may include a higher content of C₁ and C₂ than the feed gas.

In an exemplary embodiment, extracting the remaining amount of C₃⁺ in the first C₁- and C₂-rich stream may include feeding the first C₁- and C₂-rich stream to the second membrane module, retrieving a retentate stream comprising a second C₁- and C₂-rich stream from the second membrane module and retrieving a second C₃⁺-rich stream comprising a permeate stream from the second membrane module, and recycling the second C₃⁺-rich stream to feed line of the first membrane module. In an exemplary embodiment, the second C₁- and C₂-rich stream may include a higher content of C₁ and C₂ than the first C₁- and C₂-rich stream.

In an exemplary embodiment, the two-phase stream generated from first C₃⁺-rich stream may include a vapor-liquid C₃⁺-rich stream. In an exemplary embodiment, forming the separator-liquid C₃⁺-rich stream may include separating the liquid phase of the two-phase stream from the vapor phase of the two-phase stream in the separator unit at a constant temperature in a range of 25° C. to 35° C. In an exemplary embodiment, the separator-liquid C₃⁺-rich stream may include the liquid phase of the two-phase stream with a higher content of C₃⁺ than the first C₃⁺-rich stream.

In an exemplary embodiment, forming the bottoms C₃⁺-rich stream with the higher content of C₃⁺ than the separator-liquid C₃⁺-rich stream by removing volatile compounds from the separator-liquid C₃⁺-rich stream may include feeding the separator-liquid C₃⁺-rich stream to a distillation column, performing a distillation process inside the distillation column using a reboiler unit, and obtaining the bottoms C₃⁺-rich stream by withdrawing a liquid flow from the reboiler unit. In an exemplary embodiment, performing the distillation process inside the distillation column may include withdrawing a liquid stream from bottom side of the distillation column, generating a vapor flow by heating the withdrawn liquid stream in the reboiler unit to a temperature in a range of 55° C. to 75° C., and returning the generated vapor flow to the distillation column. In an exemplary embodiment, the vapor flow may include the volatile compounds of the separator-liquid C₃⁺-rich stream. In an exemplary embodiment, the liquid flow withdrawn from the reboiler unit may include non-volatile compounds of the separator-liquid C₃⁺-rich stream with a higher content of C₃⁺ than the separator-liquid C₃⁺-rich stream.

In an exemplary embodiment, adjusting the temperature of the compressed feed gas may include a primary cooling the compressed feed gas stream in the reboiler unit by transferring thermal energy of the compressed feed gas to the withdrawn liquid stream in the reboiler unit via passing the compressed feed gas through a hot side of the reboiler unit, and adjusting the temperature of the compressed feed gas at a temperature in the range of 25° C. to 35° C. by further cooling the compressed feed gas in a heat exchanger unit using a coolant fluid.

In an exemplary embodiment, recycling the second C₃⁺-rich stream to feed line of the first membrane module may include compressing the second C₃⁺-rich stream to a pressure in a range of 12 bar to 18 bar, adjusting a temperature of the compressed second C₃⁺-rich stream to a temperature in a range of 25° C. to 35° C., and feeding the compressed second C₃⁺-rich stream to the first membrane module. In an exemplary embodiment, recycling the second C₃⁺-rich stream to the first membrane module may include mixing the second C₃⁺-rich stream with the feed gas before compressing the feed gas.

In an exemplary embodiment, forming the two-phase stream may include passing the compressed first C₃⁺-rich stream through a heat exchanger unit and reducing the temperature of the compressed first C₃⁺-rich stream to the temperature in the range of 25° C. to 35° C. in the heat exchanger unit using a coolant fluid.

In an exemplary embodiment, separating the liquid phase of the two-phase stream from the vapor phase of the two-phase stream in the separator unit may include feeding the two-phase stream to the separator unit, withdrawing the liquid phase of the two-phase stream from bottom of the separator unit, and withdrawing the vapor phase of the two-phase stream from top of the separator unit. In an exemplary embodiment, the vapor phase of the two-phase stream may include a higher content of C₁ and C₂ than the first C₃⁺-rich stream. In an exemplary embodiment, a temperature of the separator unit may be at a constant temperature in the range of 25° C. to 35° C. equal to a temperature of the two-phase stream.

In an exemplary embodiment, the process may further include recovering a C₃⁺ content remaining in the vapor phase of the two-phase stream and a vapor outlet from top of the distillation column. In an exemplary embodiment, recovering the C₃⁺ content remaining in the vapor phase of the two-phase stream and the vapor outlet from top of the distillation column may include forming an overhead stream by mixing the vapor phase of the two-phase stream and the vapor outlet from top of the distillation column, feeding the overhead stream to a third membrane module, and recycling a permeate stream from the third membrane module to feed line of the first membrane module. In an exemplary embodiment, the permeate stream from the third membrane module may include a higher content of C₃⁺ than each of the vapor phase of the two-phase stream and the vapor outlet from top of the distillation column. In an exemplary embodiment, recycling the permeate stream from the third membrane module to the first membrane module may include compressing the permeate stream from the third membrane module to a pressure in a range of 12 bar to 18 bar, adjusting a temperature of the compressed permeate stream from the third membrane module to a temperature in a range of 25° C. to 35° C., and feeding the compressed permeate stream from the third membrane module to feed line of the first membrane module. In an exemplary embodiment, recycling the permeate stream from the third membrane module to the first membrane module may include mixing the permeate stream from the third membrane module with the feed gas before compressing the feed gas.

In an exemplary embodiment, an exemplary process may be done iteratively in a cycle up to obtain a content of C₁ and C₂ in a range of 0.5% to 10% in an exemplary bottoms C₃⁺-rich stream withdrawn from an exemplary reboiler unit. In an exemplary embodiment, the process may further include retrieving a retentate stream from the third membrane module comprising a third C₁- and C₂-rich stream. In an exemplary embodiment, the third C₁- and C₂-rich stream may include a higher content of C₁ and C₂ than the overhead stream. In an exemplary embodiment, the process may further include forming a C₁- and C₂-rich product stream by mixing the second C₁- and C₂-rich stream and the third C₁- and C₂-rich stream.

In an exemplary embodiment, passing the compressed feed gas through the first membrane module may include passing the compressed feed gas stream through a set of rubbery polymer membranes placed sequentially after each other. In an exemplary embodiment, feeding the first C₁- and C₂-rich stream to the second membrane module may include feeding the first C₁- and C₂-rich stream to a set of rubbery polymer membranes placed sequentially after each other. In an exemplary embodiment, feeding the overhead stream to the third membrane module may include feeding the overhead stream to a set of rubbery polymer membranes placed sequentially after each other.

### BRIEF DESCRIPTION OF THE DRAWINGS

The drawing figures depict one or more embodiments in accord with the present teachings, by way of example only, not by way of limitation. In the figures, like reference numerals refer to the same or similar elements.

FIG. 1A shows a schematic drawing of an exemplary primary process for recovery of C₃⁺ hydrocarbons form an exemplary feed gas, consistent with one or more exemplary embodiments of the present disclosure.

FIG. 1B shows a schematic view of an exemplary second process for recovery of C₃⁺ hydrocarbons form an exemplary feed gas using an exemplary compressed feed gas as an exemplary heat source in an exemplary reboiler unit by transferring thermal energy of an exemplary compressed feed gas to an exemplary withdrawn liquid stream from bottom of an exemplary distillation column, consistent with one or more exemplary embodiments of the present disclosure.

FIG. 1C shows a schematic view of an exemplary third process for recovery of C₃⁺ hydrocarbons form an exemplary feed gas including an additional membrane step for depletion of C₃⁺ from exemplary C₁- and C₂-rich product streams as much as possible, consistent with one or more exemplary embodiments of the present disclosure.

FIG. 2 shows a schematic view of an exemplary membrane module 200 for separation of a gas stream to a C₃⁺-enriched stream and a C₁ and C₂ enriched stream, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary embodiments will be readily apparent to one skilled in the art, and the general principles defined herein may be applied to other embodiments and applications without departing from the scope of the present disclosure. The present disclosure is not intended to be limited to the embodiments shown, but is to be accorded the widest possible scope consistent with the principles and features disclosed herein.

In an exemplary embodiment of the present disclosure, a process for recovery of C₃⁺ hydrocarbons form gas streams containing C₁, C₂ and C₃⁺ is disclosed. In an exemplary embodiment, an exemplary process may include compressing a feed gas containing C₁, C₂ and C₃⁺ to a pressure in a range of 12 bar to 18 bar, adjusting a temperature of an exemplary compressed feed gas to a temperature in a range of 25° C. to 35° C., forming a first C₃⁺-rich stream with a higher content of C₃⁺ than the feed gas by passing an exemplary compressed feed gas at an exemplary adjusted temperature through a first membrane module via separating an exemplary compressed feed gas at an exemplary adjusted temperature into a permeate stream including a first C₃⁺-rich stream and a retentate stream including a first C₁- and C₂-rich stream, recycling a remaining amount of C₃⁺ in an exemplary first C₁- and C₂-rich stream by enriching an exemplary first C₁- and C₂-rich stream in a second membrane module, compressing an exemplary first C₃⁺-rich stream to a pressure in a range of 12 bar to 18 bar, forming a two-phase stream by cooling an exemplary compressed first C₃⁺-rich stream to a temperature in a range of 25° C. to 35° C., separating an exemplary two-phase stream to a separator-liquid C₃⁺-rich stream comprising a liquid phase of an exemplary two-phase stream and a vapor phase of an exemplary two-phase stream in a separator unit, and forming a bottoms C₃⁺-rich stream with a higher content of C₃⁺ than an exemplary separator-liquid C₃⁺-rich stream by removing volatile compounds from an exemplary separator-liquid C₃⁺-rich stream in a distillation column.

In an exemplary embodiment, passing an exemplary compressed feed gas through an exemplary first membrane module may include feeding an exemplary compressed feed gas to an exemplary first membrane module, retrieving an exemplary permeate stream including an exemplary first C₃⁺-rich stream from an exemplary first membrane module, and retrieving an exemplary retentate stream including an exemplary first C₁- and C₂-rich stream from an exemplary first membrane module. In an exemplary embodiment, an exemplary first C₁- and C₂-rich stream may include a higher content of C₁ and C₂ than the feed gas.

In an exemplary embodiment, recycling an exemplary remaining amount of C₃⁺ in an exemplary first C₁- and C₂-rich stream by enriching an exemplary first C₁- and C₂-rich stream in an exemplary second membrane module may include feeding an exemplary first C₁- and C₂-rich stream to an exemplary second membrane module, retrieving a retentate stream including a second C₁- and C₂-rich stream from an exemplary second membrane module, and recycling a permeate stream from an exemplary second membrane module to the first membrane module. In an exemplary embodiment, an exemplary second C₁- and C₂-rich stream may include a higher content of C₁ and C₂ than an exemplary first C₁- and C₂-rich stream.

In an exemplary embodiment, an exemplary two-phase stream may include a vapor-liquid C₃⁺-rich stream. In an exemplary embodiment, forming an exemplary separator-liquid C₃⁺-rich stream may include separating an exemplary liquid phase of an exemplary two-phase stream from an exemplary vapor phase of an exemplary two-phase stream in an exemplary separator unit at a constant temperature in a range of 25° C. to 35° C. In an exemplary embodiment, an exemplary separator-liquid C₃⁺-rich stream may include an exemplary liquid phase of an exemplary two-phase stream with a higher content of C₃⁺ than an exemplary first C₃⁺-rich stream.

In an exemplary embodiment, forming an exemplary bottoms C₃⁺-rich stream with an exemplary higher content of C₃⁺ than an exemplary separator-liquid C₃⁺-rich stream by removing volatile compounds from an exemplary separator-liquid C₃⁺-rich stream may include feeding an exemplary separator-liquid C₃⁺-rich stream to a distillation column, performing a distillation process in an exemplary distillation column utilizing a reboiler unit, and obtaining an exemplary bottoms C₃⁺-rich stream by withdrawing a liquid flow from an exemplary reboiler unit. In an exemplary embodiment, performing an exemplary distillation process in an exemplary distillation column may include withdrawing a liquid stream from bottom of an exemplary distillation column, generating a vapor flow by heating an exemplary withdrawn liquid stream in an exemplary reboiler unit to a temperature in a range of 55° C. to 75° C., and returning an exemplary generated vapor flow to an exemplary distillation column. In an exemplary embodiment, an exemplary vapor flow may include an exemplary volatile compound of an exemplary separator-liquid C₃⁺-rich stream. In an exemplary embodiment, an exemplary liquid flow withdrawn from an exemplary reboiler unit may include non-volatile compounds of an exemplary separator-liquid C₃⁺-rich stream with a higher content of C₃⁺ than an exemplary separator-liquid C₃⁺-rich stream.

In an exemplary embodiment, adjusting an exemplary temperature of an exemplary compressed feed gas may include cooling an exemplary compressed feed gas in an exemplary reboiler unit. In an exemplary embodiment, cooling an exemplary compressed gas stream may include transferring thermal energy of an exemplary compressed feed gas to an exemplary withdrawn liquid stream in an exemplary reboiler unit by passing an exemplary compressed feed gas through an exemplary reboiler unit. In an exemplary embodiment, adjusting an exemplary temperature of an exemplary compressed feed gas may further include cooling an exemplary compressed feed gas in a heat exchanger unit to a temperature of 25° C. to 35° C.

In an exemplary embodiment, adjusting an exemplary temperature of an exemplary compressed feed gas may include two step cooling an exemplary compressed feed gas stream, firstly decreasing temperature of an exemplary compressed feed gas in an exemplary reboiler unit by transferring thermal energy of an exemplary compressed feed gas to an exemplary withdrawn liquid stream in an exemplary reboiler unit via passing an exemplary compressed feed gas through an exemplary reboiler unit, and secondly, adjusting an exemplary temperature of an exemplary compressed feed gas at a temperature in an exemplary range of 25° C. to 35° C. by further cooling an exemplary compressed feed gas in a heat exchanger unit using a coolant fluid.

In an exemplary embodiment, recycling an exemplary permeate stream from an exemplary second membrane module to an exemplary first membrane module may include compressing an exemplary permeate stream from an exemplary second membrane module to a pressure in a range of 12 bar to 18 bar, adjusting a temperature of an exemplary compressed permeate stream from an exemplary second membrane module to a temperature in a range of 25° C. to 35° C., and feeding an exemplary compressed permeate stream from an exemplary second membrane module to an exemplary first membrane module. In an exemplary embodiment, recycling an exemplary permeate stream from an exemplary second membrane module to an exemplary first membrane module may include mixing an exemplary permeate stream from an exemplary second membrane module with an exemplary feed gas before compressing an exemplary feed gas.

In an exemplary embodiment, forming an exemplary two-phase stream may include passing an exemplary compressed first C₃⁺-rich stream through a heat exchanger unit and reducing an exemplary temperature of an exemplary compressed first C₃⁺-rich stream to an exemplary temperature in an exemplary range of 25° C. to 35° C. in an exemplary heat exchanger unit using a coolant fluid.

In an exemplary embodiment, separating an exemplary liquid phase of an exemplary two-phase stream from an exemplary vapor phase of an exemplary two-phase stream in an exemplary separator unit may include feeding an exemplary two-phase stream to an exemplary separator unit, withdrawing an exemplary liquid phase of an exemplary two-phase stream from bottom of an exemplary separator unit, and withdrawing an exemplary vapor phase of an exemplary two-phase stream from top of an exemplary separator unit. In an exemplary embodiment, an exemplary vapor phase of an exemplary two-phase stream may include a higher content of C₁ and C₂ than an exemplary first C₃⁺-rich stream. In an exemplary embodiment, an exemplary separator unit may operate at an exemplary constant temperature in an exemplary range of 25° C. to 35° C. equal to a temperature of an exemplary two-phase stream.

In an exemplary embodiment, an exemplary process may further include recovering a C₃⁺ content remaining in an exemplary vapor phase of an exemplary two-phase stream and a vapor outlet from top of an exemplary distillation column. In an exemplary embodiment, recovering an exemplary C₃⁺ content remaining in an exemplary vapor phase of an exemplary two-phase stream and an exemplary vapor outlet from top of an exemplary distillation column may include forming an overhead stream by mixing an exemplary vapor phase of an exemplary two-phase stream and an exemplary vapor outlet from top of an exemplary distillation column, feeding an exemplary overhead stream to a third membrane module, and recycling a permeate stream from an exemplary third membrane module to an exemplary first membrane module. In an exemplary embodiment, an exemplary permeate stream from an exemplary third membrane module may include a higher content of C₃⁺ than each of an exemplary vapor phase of an exemplary two-phase stream and an exemplary vapor outlet from top of an exemplary distillation column. In an exemplary embodiment, recycling an exemplary permeate stream from an exemplary third membrane module to an exemplary first membrane module may include compressing an exemplary permeate stream from an exemplary third membrane module to a pressure in a range of 12 bar to 18 bar, adjusting a temperature of an exemplary compressed permeate stream from an exemplary third membrane module to a temperature in a range of 25° C. to 35° C., and feeding an exemplary compressed permeate stream from an exemplary third membrane module to an exemplary first membrane module. In an exemplary embodiment, recycling an exemplary permeate stream from an exemplary third membrane module to an exemplary first membrane module may include mixing an exemplary permeate stream from an exemplary third membrane module with an exemplary feed gas before compressing an exemplary feed gas.

In an exemplary embodiment, an exemplary process may further include retrieving a retentate stream from an exemplary third membrane module comprising a third C₁- and C₂-rich stream. In an exemplary embodiment, an exemplary third C₁- and C₂-rich stream may include a higher content of C₁ and C₂ than an exemplary overhead stream. In an exemplary embodiment, an exemplary process may further include forming a C₁- and C₂-rich product stream by mixing an exemplary second C₁- and C₂-rich stream and an exemplary third C₁- and C₂-rich stream. In an exemplary embodiment, an exemplary process may be done iteratively in a cycle up to obtain a content of C₁ and C₂ in a range of 0.5% to 10% in an exemplary bottoms C₃⁺-rich stream withdrawn from an exemplary reboiler unit.

In an exemplary embodiment, passing an exemplary compressed feed gas through an exemplary first membrane module may include passing an exemplary compressed feed gas stream through a set of rubbery polymer membranes placed sequentially after each other. In an exemplary embodiment, feeding an exemplary first C₁- and C₂-rich stream to an exemplary second membrane module may include feeding an exemplary first C₁- and C₂-rich stream to a set of rubbery polymer membranes placed sequentially after each other. In an exemplary embodiment, feeding an exemplary overhead stream to an exemplary third membrane module may include feeding an exemplary overhead stream to a set of rubbery polymer membranes placed sequentially after each other.

As used herein, each of C₁, C₂, C₃, and so on may refer to hydrocarbons and their derivatives having carbon atoms equal to the subscript carbon number. For example, C₁ refers to a hydrocarbon having one carbon atom in its compound (i.e., methane). Accordingly, C₃⁺ refers to hydrocarbons with three or more carbon atoms in their formulation. In an exemplary embodiment, liquefied petroleum gas (LPG) may include C₃⁺, mainly, C₃ and C₄, and less amount of C₅ and higher hydrocarbons.

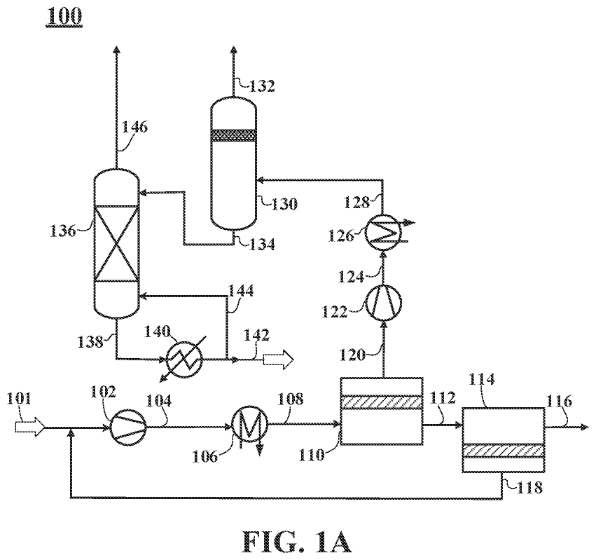

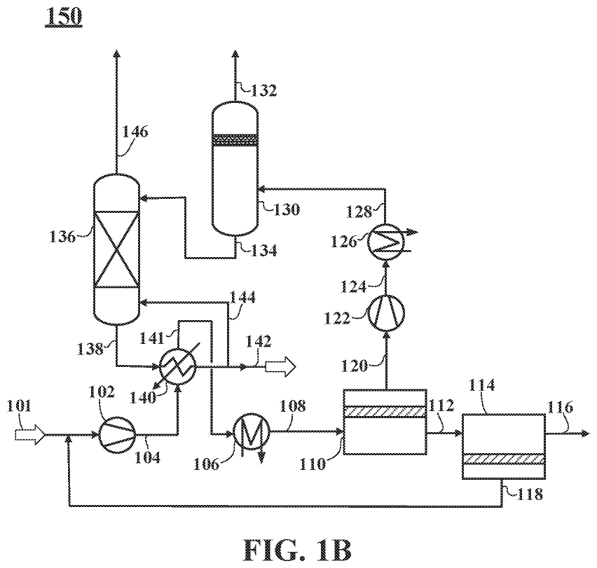

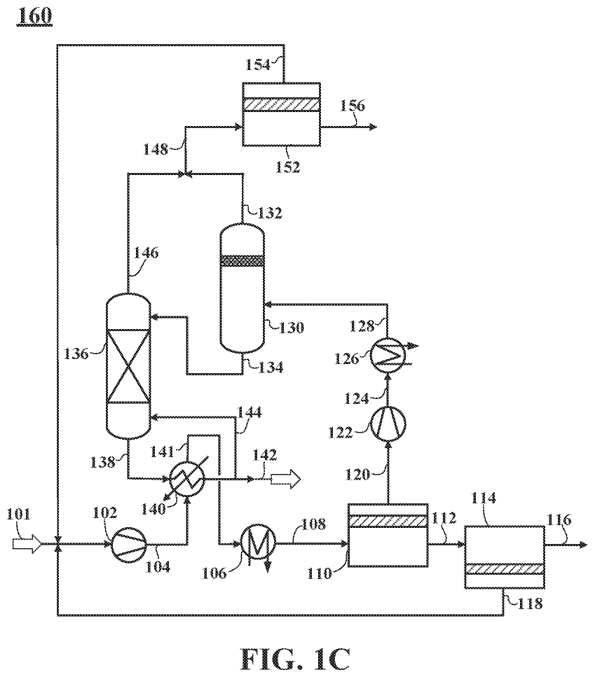

FIG. 1A shows a schematic view of a primary process 100 for recovery of C₃⁺ hydrocarbons form a feed gas 101, consistent with one or more exemplary embodiments of the present disclosure. Exemplary process 100 may include performing three main steps of enriching feed gas 101 in C₃⁺ iteratively in a cycle up to obtaining a target concentration of C₃⁺ in a product C₃⁺ stream. In an exemplary embodiment, process 100 may include forming a first C₃⁺-rich stream 120 with a higher content of C₃⁺ than feed gas 101 by removing a first amount of C₁ and C₂ hydrocarbons from feed gas 101 in a first membrane module 110, forming a separator-liquid C₃⁺-rich stream 134 with a higher content of C₃⁺ than first C₃⁺-rich stream 120 by removing a second amount of C₁ and C₂ hydrocarbons from first C₃⁺-rich stream 120 in a separator unit 130, and forming a bottoms C₃⁺-rich stream 142 with a higher content of C₃⁺ than separator-liquid C₃⁺-rich stream 134 by removing a third amount of C₁ and C₂ hydrocarbons from separator-liquid C₃⁺-rich stream 134 in a distillation column 136 and associated reboiler unit 140.

In an exemplary embodiment, feed gas 101 may include a gas stream containing hydrocarbons. In an exemplary embodiment, feed gas 101 may include a gas stream containing C₁, C₂ and C₃⁺ hydrocarbons. In an exemplary embodiment, feed gas 101 may include a gas stream containing light hydrocarbons (i.e., C₁ and C₂ hydrocarbons) and heavy hydrocarbons (i.e., C₃⁺ hydrocarbons). In an exemplary embodiment, C₃⁺ hydrocarbons may refer to liquefied petroleum gas (LPG). In an exemplary embodiment, feed gas 101 may include a hydrocarbon source stream. In an exemplary embodiment, feed gas 101 may include a hydrocarbon-containing stream formed or obtained as a byproduct of a process of at least one of natural gas production, oil extraction, crude oil refining, and combinations thereof. In an exemplary embodiment, feed gas 101 may include a gas stream produced in a refinery process. In an exemplary embodiment, feed gas 101 may include a fuel gas stream.

With further detail in regards to step of forming a first C₃⁺-rich stream 120 with a higher content of C₃⁺ than feed gas 101, a first amount of C₁ and C₂ hydrocarbons may be separated from feed gas 101 via steps of compressing feed gas 101 to a pressure in a range of about 12 bar to 18 bar in a first compressor 102, adjusting a temperature of compressed feed gas 104 by cooling compressed feed gas 104 in a first heat exchanger 106, and separating cooled compressed feed gas 108 at a temperature of about 25° C. to about 35° C. into first C₃⁺-rich stream 120 and a first C₁- and C₂-rich stream 112 in first membrane module 110.

In an exemplary embodiment, feed gas 101 may be fed to first compressor 102; thereby, resulting in forming compressed feed gas 104 with a pressure in a range of about 12 bar to 18 bar. In an exemplary embodiment, feed gas 101 may be compressed to a pressure of about 15 bar. In an exemplary embodiment, compressed feed gas 104 may be fed to first heat exchanger 106, where a temperature of compressed feed gas 104 may be adjusted to a temperature in a range of about 25° C. to about 35° C. by cooling compressed feed gas 104 in first heat exchanger 106. In an exemplary embodiment, compressed feed gas 104 may be cooled to a temperature of about 30° C. in first heat exchanger 106. In an exemplary embodiment, compressed feed gas 104 may be cooled in first heat exchanger 106 using a coolant fluid. In an exemplary embodiment, an exemplary coolant fluid may include air or water. In an exemplary embodiment, first heat exchanger 106 may include a water-cooled heat exchanger or an air-cooled heat exchanger.

Furthermore, cooled compressed feed gas 108 may be fed to first membrane module 110 where cooled compressed feed gas 108 may be contacted with a membrane capable of separating C₃⁺ hydrocarbons from C₁ and C₂ hydrocarbons. In an exemplary embodiment, cooled compressed feed gas 108 may be contacted with a rubbery polymer membrane. In an exemplary embodiment, cooled compressed feed gas 108 may be fed to first membrane module 110 at a pressure of about 15 bar and a temperature of about 30° C. In an exemplary embodiment, cooled compressed feed gas 108 may be divided into first C₃⁺-rich stream 120 and first C₁- and C₂-rich stream 112. In an exemplary embodiment, first C₃⁺-rich stream 120 may be a C₃⁺-enriched permeate stream and first C₁- and C₂-rich stream 112 may be a C₁ and C₂ enriched retentate stream. In an exemplary embodiment, first C₃⁺-rich stream 120 may have a higher content of C₃⁺ than feed gas 101. In an exemplary embodiment, first C₃⁺-rich stream 120 may be formed by passing cooled compressed feed gas 108 through first membrane module 110. In an exemplary embodiment, passing cooled compressed feed gas 108 through first membrane module 110 may include feeding cooled compressed feed gas 108 to first membrane module 110, retrieving a permeate stream comprising first C₃⁺-rich stream 120 from first membrane module 110, and retrieving a retentate stream comprising a first C₁- and C₂-rich stream 112 from first membrane module 110. In an exemplary embodiment, first C₁- and C₂-rich stream 112 may include a higher content of C₁ and C₂ than feed gas 101.

In an exemplary embodiment, first C₁- and C₂-rich stream 112 may be further enriched in C₁ and C₂ hydrocarbons and a remaining content of C₃⁺ hydrocarbons in first C₁- and C₂-rich stream 112 may be recovered by passing first C₁- and C₂-rich stream 112 through a second membrane module 114. In an exemplary embodiment, first C₁- and C₂-rich stream 112 may be fed to second membrane module 114 where first C₁- and C₂-rich stream 112 may be divided into a retentate stream comprising a second C₁- and C₂-rich stream 116 and a permeate stream comprising a second C₃⁺-rich stream 118. In an exemplary embodiment, second C₃⁺-rich stream 118 may include a remaining amount of C₃⁺ hydrocarbons in first C₁- and C₂-rich stream 112. In an exemplary embodiment, second C₁- and C₂-rich stream 116 may include a higher content of C₁ and C₂ than first C₁- and C₂-rich stream 112. In an exemplary embodiment, second C₃⁺-rich stream 118 may be retrieved from second membrane module 114 and may be recycled to first membrane module 110, leading to obtaining a more purified stream of C₁ and C₂ hydrocarbons comprising second C₁- and C₂-rich stream 116 and increasing a C₃⁺ content of first C₃⁺-rich stream 120 by recovering second C₃⁺-rich stream 118 comprising remaining amount of C₃⁺ hydrocarbons in first C₁- and C₂-rich stream 112. In an exemplary embodiment, surface area of second membrane module 114 may control an exemplary amount of C₃⁺ hydrocarbons recovered in second C₃⁺-rich stream 118. In more detail, a pressure of first C₁- and C₂-rich stream 112 may be controlled/adjusted by first compressor 102 and a temperature of first C₁- and C₂-rich stream 112 may be controlled/adjusted by first heat exchanger 106. Therefore, increasing a surface area of second membrane module 114 may increase a stage cut ratio, which may lead to an increase of volume flow rate of second C₃⁺-rich stream 118 compared to first C₁- and C₂-rich stream 112; thereby, resulting in increasing an amount of C₃⁺ recovery in whole exemplary process. Furthermore, another consequence of this may be an increase of concentration of C₁ in second C₁- and C₂-rich stream 116.

In an exemplary embodiment, recovering second C₃⁺-rich stream 118 may include recycling second C₃⁺-rich stream 118 to first membrane module 110. In an exemplary embodiment, recycling second C₃⁺-rich stream 118 to first membrane module 110 may include compressing second C₃⁺-rich stream 118 to a pressure in a range of 12 bar to 18 bar, adjusting a temperature of compressed second C₃⁺-rich stream 118 to a temperature in a range of about 25° C. to about 35° C., and feeding compressed second C₃⁺-rich stream 118 at adjusted temperature to first membrane module 110. In an exemplary embodiment, recycling second C₃⁺-rich stream 118 to first membrane module 110 may include mixing second C₃⁺-rich stream 118 retrieved from second membrane module 114 with feed gas 101; thereby, second C₃⁺-rich stream 118 may be compressed in first compressor 102 to a pressure in a range of 12 bar to 18 bar and cooled to a temperature in a range of about 25° C. to about 35° C. in first heat exchanger 106 along with feed gas 101.

In an exemplary embodiment, second C₁- and C₂-rich stream 116 may be withdrawn from second membrane module 114 as a product stream mainly enriched in C₁ hydrocarbons. In an exemplary embodiment, second C₁- and C₂-rich stream 116 may be used for domestic consumption and/or consuming as a fuel gas for process units, for example, boilers, etc.

Furthermore, first C₃⁺-rich stream 120 may be more purified relative to C₃⁺ compounds by removing remaining light C₁ and C₂ compounds in first C₃⁺-rich stream 120 via a two-phase forming process. In an exemplary embodiment, first C₃⁺-rich stream 120 may be more enriched in C₃⁺ leading to form separator-liquid C₃⁺-rich stream 134 with a higher content of C₃⁺ than first C₃⁺-rich stream 120 by removing a remaining amount of C₁ and C₂ hydrocarbons from first C₃⁺-rich stream 120. In an exemplary embodiment, forming separator-liquid C₃⁺-rich stream 134 may include compressing first C₃⁺-rich stream 120 to a pressure in a range of about 12 bar to about 18 bar, forming a two-phase stream 128 by cooling compressed first C₃⁺-rich stream 124, and separating a liquid phase of two-phase stream 128 in a separator unit 130.

In details, forming two-phase stream 128 may include passing compressed first C₃⁺-rich stream 124 through a second heat exchanger 126 and reducing temperature of compressed first C₃⁺-rich stream 124 to a temperature in a range of about 25° C. to about 35° C. in second heat exchanger 126 using a coolant fluid. In an exemplary embodiment, an exemplary coolant fluid may include air or water. In an exemplary embodiment, second heat exchanger 126 may include a water-cooled heat exchanger or an air-cooled heat exchanger. In an exemplary embodiment, first C₃⁺-rich stream 120 may be compressed in a second compressor 122 to a pressure of about 15 bar, leading to forming compressed first C₃⁺-rich stream 124. In an exemplary embodiment, compressed first C₃⁺-rich stream 124 may be cooled to a temperature in a range of about 25° C. to about 35° C. in second heat exchanger 126; thereby, two-phase stream 128 may be formed. In an exemplary embodiment, two-phase stream 128 may be formed by cooling compressed first C₃⁺-rich stream 124 to a temperature of about 30° C. In an exemplary embodiment, two-phase stream 128 may comprise a vapor-liquid C₃⁺-rich stream. Furthermore, separator-liquid C₃⁺-rich stream 134 may be formed by separating a liquid phase of two-phase stream 128 from a vapor phase 132 of two-phase stream 128. In an exemplary embodiment, liquid phase of two-phase stream 128 may comprise separator-liquid C₃⁺-rich stream 134. In an exemplary embodiment, separator-liquid C₃⁺-rich stream 134 may be separated as an exemplary liquid phase of two-phase stream 128 from vapor phase 132 of two-phase stream 128 in separator unit 130 at a constant temperature in a range of about 25° C. to about 35° C. In an exemplary embodiment, separator-liquid C₃⁺-rich stream 134 may comprise an exemplary liquid phase of two-phase stream 128 with a higher content of C₃⁺ than first C₃⁺-rich stream 120. In an exemplary embodiment, separating separator-liquid C₃⁺-rich stream 134 as an exemplary liquid phase of two-phase stream 128 from vapor phase 132 of two-phase stream 128 may include feeding two-phase stream 128 to separator unit 130, withdrawing liquid phase of two-phase stream 128 (separator-liquid C₃⁺-rich stream 134) from bottom side of separator unit 130, and withdrawing vapor phase 132 of two-phase stream 128 from top of separator unit 130. In an exemplary embodiment, vapor phase 132 of two-phase stream 128 may include a higher content of C₁ and C₂ than first C₃⁺-rich stream 120. In an exemplary embodiment, a temperature of separator unit 130 may include a constant temperature in a range of about 25° C. to about 35° C., for example, a constant temperature of about 30° C. In an exemplary embodiment, a temperature of separator unit 130 may be equal to a temperature of two-phase stream 128 entered from second heat exchanger 126 to separator unit 130.

Additionally, separator-liquid C₃⁺-rich stream 134 may be more enriched in C₃⁺ compounds in distillation column 136. In an exemplary embodiment, bottoms C₃⁺-rich stream 142 with a higher content of C₃⁺ than separator-liquid C₃⁺-rich stream 134 may be formed by removing a remaining amount of C₁ and C₂ hydrocarbons in separator-liquid C₃⁺-rich stream 134 in distillation column 136 and associated reboiler unit 140. In an exemplary embodiment, bottoms C₃⁺-rich stream 142 may be formed by removing volatile light compounds from separator-liquid C₃⁺-rich stream 134. In an exemplary embodiment, forming bottoms C₃⁺-rich stream 142 may include feeding separator-liquid C₃⁺-rich stream 134 to distillation column 136, performing a distillation process in distillation column 136 using a reboiler unit 140, and obtaining bottoms C₃⁺-rich stream 142 as a withdrawn liquid flow from reboiler unit 140. In an exemplary embodiment, performing an exemplary distillation process inside distillation column 136 may include withdrawing a liquid stream 138 from bottom of distillation column 136, generating a vapor flow 144 by heating withdrawn liquid stream 138 in reboiler unit 140 to a temperature in a range of about 55° C. to about 75° C., and returning generated vapor flow 144 to distillation column 136. In an exemplary embodiment, vapor flow 144 may mainly include volatile compounds of separator-liquid C₃⁺-rich stream 134. In an exemplary embodiment, vapor flow 144 may drive an exemplary distillation process in distillation column 136, leading to separating light compounds of separator-liquid C₃⁺-rich stream 134 in form of vapor outlet 146 withdrawn from top of distillation column 136 and heavy compounds of separator-liquid C₃⁺-rich stream 134 in form of liquid stream 138 from bottom of distillation column 136. In an exemplary embodiment, vapor outlet 146 may mainly include C₁ and C₂ compounds with a higher content of C₁ and C₂ than separator-liquid C₃⁺-rich stream 134.

In an exemplary embodiment, bottoms C₃⁺-rich stream 142 may comprise a liquid flow enriched in C₃⁺ exited from reboiler unit 140. In an exemplary embodiment, bottoms C₃⁺-rich stream 142 may mainly include non-volatile compounds of the separator-liquid C₃⁺-rich stream. In an exemplary embodiment, bottoms C₃⁺-rich stream 142 may have a higher content of C₃⁺ than separator-liquid C₃⁺-rich stream 134. In an exemplary embodiment, bottoms C₃⁺-rich stream 142 may comprise a LPG stream forming main product of exemplary process 100. In an exemplary embodiment, bottoms C₃⁺-rich stream 142 may contain ultra-low amounts of C₁ and C₂. In an exemplary embodiment, bottoms C₃⁺-rich stream 142 may contain an amount of C₁ and C₂ in a range of about 0.5% to about 10%. In an exemplary embodiment, exemplary process 100 may be done iteratively in a cycle up to obtain a content of C₁ and C₂ in a range of about 0.5% to about 10% in bottoms C₃⁺-rich stream 142 withdrawn from reboiler unit 140. In an exemplary embodiment, an amount of C₁ and C₂ compounds, and more specifically, an amount of C₂ compounds in produced bottoms C₃⁺-rich stream 142 may be controlled and adjusted by adjusting a temperature of reboiler unit 140.

FIG. 1B shows a schematic view of a second process 150 for recovery of C₃⁺ hydrocarbons form a feed gas 101 using compressed feed gas 104 as a heat source in reboiler unit 140 by transferring thermal energy of compressed feed gas 104 to withdrawn liquid stream 138 from bottom of distillation column 136, consistent with one or more exemplary embodiments of the present disclosure. In an exemplary embodiment, exemplary process 150 may contain elements and steps similar to exemplary process 100 while further including using a thermal energy of compressed feed gas 104 for boiling liquid stream 138 in reboiler unit 140. In an exemplary embodiment, thermal energy of compressed feed gas 104 may be transferred to liquid stream 138 in reboiler unit 140; thereby, no external heat source may be required for reboiler unit 140. In addition, temperature of compressed feed gas 104 may be dropped in reboiler unit 140 by cooling compressed feed gas 104 there. In an exemplary embodiment, decreasing a temperature of compressed feed gas 104 may include transferring thermal energy of compressed feed gas 104 to withdrawn liquid stream 138 in reboiler unit 140 by passing compressed feed gas 104 through reboiler unit. In an exemplary embodiment, transferring thermal energy of compressed feed gas 104 to withdrawn liquid stream 138 in reboiler unit 140 may include boiling withdrawn liquid stream 138 in reboiler unit 140 using thermal energy of compressed feed gas 104 by passing compressed feed gas 104 through a hot side of reboiler unit 140 and passing withdrawn liquid stream 138 through a cold side of reboiler unit 140.

In another exemplary embodiment, decreasing a temperature of compressed feed gas 104 may include adjusting a temperature of compressed feed gas 104 in a temperature range of about 25° C. to about 35° C. may include a two-step cooling of compressed feed gas 104, including transferring thermal energy of compressed feed gas 104 to withdrawn liquid stream 138 in reboiler unit 140 by passing compressed feed gas 104 through reboiler unit, and then passing compressed feed gas 104 through first heat exchanger 106. In such embodiments, primary-cooled compressed feed gas 141 may be withdrawn from reboiler unit 140 and may be cooled to a temperature in a range of about 25° C. to about 35° C. via a secondary cooling step in first heat exchanger 106.

FIG. 1C shows a schematic view of a third process 160 for recovery of C₃⁺ hydrocarbons form a feed gas 101 including an additional membrane step for depletion of C₃⁺ from C₁- and C₂-rich product streams as much as possible, consistent with one or more exemplary embodiments of the present disclosure. In an exemplary embodiment, exemplary process 160 may contain elements and steps similar to exemplary process 100 and or exemplary process 150 while further including recovering a C₃⁺ content remaining in vapor phase 132 discharged from separator unit 130 and vapor outlet 146 discharged from distillation column 136. In an exemplary embodiment, an exemplary C₃⁺ content remaining in vapor phase 132 and vapor outlet 146 may be recovered by a separation process utilizing a third membrane module 152. In an exemplary embodiment, an overhead stream 148 may be formed by mixing vapor phase 132 discharged from separator unit 130 and vapor outlet 146 discharged from distillation column 136. It should be noted that thermodynamic conditions of vapor phase 132 exiting from separator unit 130 and vapor outlet 146 exiting from distillation column 136 may be very close to each other and they can be mixed together to form a feed stream to be fed to third membrane module 152. Furthermore, overhead stream 148 may be fed to third membrane module 152 where overhead stream 148 may be separated into a permeate stream 154 enriched in C₃⁺ and a retentate stream comprising a third C₁- and C₂-rich stream 156 enriched in C₁ and C₂, and mainly enriched in C₂. In an exemplary embodiment, permeate stream 154 from third membrane module 152 may include a higher content of C₃⁺ than each of vapor phase 132 exiting from separator unit 130 and vapor outlet 146 exiting from top of distillation column 136. In an exemplary embodiment, permeate stream 154 may be recycled to first membrane module 110. In an exemplary embodiment, recycling permeate stream 154 from third membrane module 152 to first membrane module 110 may include compressing permeate stream 154 to a pressure in a range of about 12 bar to about 18 bar, adjusting a temperature of compressed permeate stream 154 to a temperature in a range of about 25° C. to about 35° C., and feeding compressed permeate stream 154 at adjusted temperature to first membrane module 110. In an exemplary embodiment, recycling permeate stream 154 from third membrane module 152 to first membrane module 110 may include mixing permeate stream 154 with feed gas 101 before compressing feed gas 101.

In an exemplary embodiment, exemplary process 160 may further include retrieving a retentate stream from third membrane module 152 comprising third C₁- and C₂-rich stream 156. In an exemplary embodiment, third C₁- and C₂-rich stream 156 may include a stream having a higher content of C₁ and C₂ than overhead stream 148. In an exemplary embodiment, exemplary process 160 may further include forming a C₁- and C₂-rich product stream by mixing second and third C₁- and C₂-rich streams 116 and 156. In an exemplary embodiment, second C₁- and C₂-rich stream 116 and/or third C₁- and C₂-rich stream 156 may be used for domestic consumption and/or consuming as a fuel gas for process units, for example, boilers, etc.

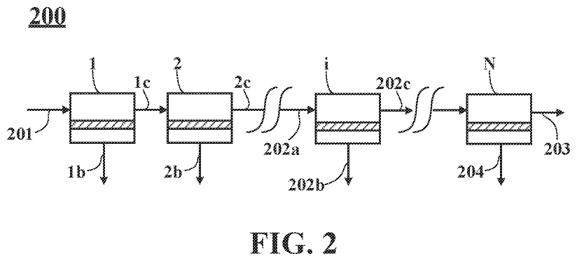

In an exemplary embodiment, each of first membrane module 110, second membrane module 114, and third membrane module 152 may include a set of membrane units placed sequentially after each other. FIG. 2 shows a schematic view of an exemplary membrane module 200 for separation of a gas stream to a C₃⁺ enriched stream and a C₁- and C₂-rich stream, consistent with one or more exemplary embodiments of the present disclosure. In an exemplary embodiment, each of first membrane module 110, second membrane module 114, and third membrane module 152 may be similar to membrane module 200. In an exemplary embodiment, membrane module 200 may include a set of membrane units 1 to N (1, 2, . . . , i, . . . , and N). In an exemplary embodiment, a feed stream 201 may be fed to first membrane unit 1 to be separated into a permeate stream 1b enriched in C₃⁺ relative to feed stream 201 and a retentate stream 1c enriched in C₁ and C₂ relative to feed stream 201. In an exemplary embodiment, a separation process similar to an exemplary separation process of first membrane 1 may be performed in each membrane unit i. In detail, a retentate stream 202a from a membrane unit i−1 may be fed to membrane unit i and may be separated into a permeate stream 202b enriched in C₃⁺ relative to retentate stream 202a from membrane unit i−1 and a retentate stream 202c enriched in C₁ and C₂ relative to retentate stream 202a from a membrane unit i−1. In an exemplary embodiment, N permeate streams may be retrieved from respective N membrane units and may be mixed together, thereby a total permeate stream may be formed. In an exemplary embodiment, one or more permeate streams may be recycled to a membrane unit of membrane units of membrane module 200 for more recovery of C₃⁺ compounds. In another exemplary embodiment, one or more retentate streams may be fed to a membrane unit of membrane units of membrane module 200 for more retrieving of C₃⁺ compounds remaining in retentate streams. In an exemplary embodiment, each exemplary membrane unit i may include a permselective membrane. In an exemplary embodiment, an exemplary permselective membrane may include rubbery polymers. In an exemplary embodiment, an exemplary permselective membrane may be categorized in a group of reverse selective membranes. In an exemplary embodiment, an exemplary permselective membrane may be capable of separating vapors from supercritical gases.

### Example 1: Permeation Properties of a Multicomponent Gas Mixture in Membrane Modules

In this example, an experiment was carried out to determine permeation properties of membrane modules used as examples of membrane modules first membrane module 110, second membrane module 114, and/or third membrane module 152 using a multicomponent gas mixture as feed stream with a composition presented in Table 1. Specifications of retentate and permeate streams are also presented in Table 1.

TABLE 1
Specifications of membrane feed, retentate and permeate

| | Feed | Permeate | Retentate |
|---|---|---|---|
| Component | (mol %) | (mol % ) | (mol %) |
| C₁ | 25.38 | 11.97 | 34.37 |
| C₂ | 20.97 | 19.03 | 22.27 |
| C₃ | 24.42 | 28.11 | 21.95 |
| nC₄ | 14.21 | 21.06 | 9.61 |
| iC₄ | 07.12 | 8.11 | 6.46 |
| C₅⁺ | 6.56 | 10.33 | 4.04 |
| CO₂ | 1.34 | 1.39 | 1.30 |
| Flow rate (Sm³/h) | 1,919 | 770 | 1,149 |

Membrane permeation properties of Table 1 were conducted at 30° C. while the feed and the permeate pressures were maintained at 15 and 3 bar, respectively. Moreover, based on the results of Table 1, a computer program was developed and used for the comparative examples presented herein. The permselective membranes used herein were rubbery polymers, which their performance can be categorized as reverse selective membranes. These membranes can separate vapors from supercritical gases. As results of Table 1 shows, heavy components (C₃⁺) permeate through membrane to the permeate side while lighter gases like C₁ remain in upstream of the membrane module and their concentration is increased in the retentate stream. Relatively low selectivity of heavy components compared to C₂ causes that the concentration of C₂ in permeate and retentate to be nearly equal to its concentration in the feed stream. Deficiency in decreasing concentration of C₂ in the permeate stream may cause some C₂ to be remained in the liquid LPG product. Presence of C₂ in the final product may increase its vapor pressure in the liquefaction process of LPG which is an undesirable phenomenon. Whereas, method described herein may be a suitable procedure to tackle this problem and to decrease concentration of C₂ in an exemplary final liquid LPG product. Therefore, an LPG product produced based on procedures presented herein may be a product with higher quality in comparison with those produced by common LPG recovery processes.

### Example 2: LPG Recovery from a Gas Stream

In this example, a process similar to exemplary process 160 described herein above was conducted for recovery of LPG from a feed gas stream. A feed gas stream containing C₁, C₂ and C₃⁺ was used as feed gas 101. A process similar to exemplary process 160 was carried out for recovery of C₃⁺ from the feed gas stream with three different scenarios for C₂ composition in bottoms C₃⁺-rich stream 142. Mass flow rate of the feed gas stream was 3,155 kg/h and its composition was the same as those presented in Table 1. Specifications of the product streams are presented in Table 2. Product streams of each exemplary process includes a C₃⁺ LPG stream similar to bottoms C₃⁺-rich stream 142, a C₁-rich stream similar to second C₁- and C₂-rich stream 116, and a C₂-rich stream similar to third C₁- and C₂-rich stream 156.

TABLE 2
Specifications of the obtained product streams with three different
scenarios for C₂ composition in LPG product (0.5, 5, and 10 mol %)

| | | C₁ | C₂ | C₃ | nC₄ | iC₄ | C₅⁺ | CO₂ | Flow |
|---|---|---|---|---|---|---|---|---|---|
| Example | Stream | mol % | | | | | | | kg/h |
| 1 | C₁-Rich | 47.29 | 30.56 | 14.62 | 1.98 | 3.19 | 0.52 | 1.84 | 894.9 |
| | Stream | | | | | | | | |
| | C₂-Rich | 31.14 | 41.56 | 18.75 | 2.55 | 2.61 | 0.47 | 2.92 | 503.8 |
| | Stream | | | | | | | | |
| | C₃⁺ LPG | 0.00 | 0.50 | 37.38 | 32.75 | 13.48 | 15.89 | 0.00 | 1756.3 |
| | Stream | | | | | | | | |

C₃⁺ wt % Recovered = 77.58
Compressor Power = 311 kW

| | | | | | | | | | |
|---|---|---|---|---|---|---|---|---|---|
| 2 | C₁-Rich | 53.95 | 29.31 | 10.49 | 0.89 | 3.04 | 0.39 | 1.93 | 721.0 |
| | Stream | | | | | | | | |
| | C₂-Rich | 32.64 | 42.10 | 17.63 | 1.77 | 2.36 | 0.22 | 3.28 | 486.9 |
| | Stream | | | | | | | | |
| | C₃⁺ LPG | 0.00 | 5.00 | 37.74 | 30.14 | 12.64 | 14.48 | 0.00 | 1946.7 |
| | Stream | | | | | | | | |

C₃⁺ wt % Recovered = 85.98
Compressor Power = 315 kW

| | | | | | | | | | |
|---|---|---|---|---|---|---|---|---|---|
| 3 | C₁-Rich | 53.74 | 28.62 | 11.25 | 1.04 | 2.84 | 0.14 | 2.37 | 763.7 |
| | Stream | | | | | | | | |
| | C₂-Rich | 39.34 | 38.91 | 15.02 | 1.33 | 2.04 | 0.16 | 3.20 | 325.9 |
| | Stream | | | | | | | | |
| | C₃⁺ LPG | 0.00 | 10.00 | 37.06 | 27.85 | 11.82 | 13.26 | 0.01 | 2065.4 |
| | Stream | | | | | | | | |

C₃⁺ wt % Recovered = 91.21
Compressor Power = 318 kW

In detail, the feed gas stream was compressed to 15 bar and its temperature was adjusted to 30° C. Then, the feed gas stream was fed to a first membrane module similar to first membrane module 110. A retentate stream from the first membrane module entered a second membrane module similar to second membrane module 114 and was enriched in C₁ and C₂ light compounds, particularly in C₁. The second membrane module may considerably affect overall LPG recovery of an exemplary process. A permeate stream of the second membrane module at 5 bar was recycled to feed compression unit and fed again to the first membrane module. A permeate stream of the first membrane unit is rich in C₃⁺ heavy compounds. The permeate stream of the first membrane unit at 5 bar was fed to a compression unit to increase its pressure to 15 bar. The compressed permeate stream of the first membrane unit became a two-phase stream after passing through a heat exchanger and reducing its temperature to 30° C. Liquid and vapor phases of the two-phase stream were separated in a two-phase (vapor-liquid) separator similar to separator unit 130 at a constant temperature of 30° C. The liquid phase exiting the separator was fed to a distillation column similar to distillation column 136. A reboiler, similar to reboiler unit 140, at bottom of the distillation column working at a temperature range of 55-75° C. generated a vapor flow, which returns to the distillation column to drive a distillation separation process. Vapor streams from the two-phase separator and top of the distillation column were mixed together and formed a feed stream of a third membrane module similar to third membrane module 152. It should be noted that thermodynamic conditions of the vapor phase exiting from the two-phase separator and the distillation column were very close to each other and they were mixed together to form the feed of the third membrane unit. A retentate stream from the third membrane module was enriched in C₁ and C₂ compounds, and a permeate stream of this module recovered C₃⁺ compounds. The permeate stream from the third membrane module formed a return flow that was fed to the feed compression unit. The retentate streams of the second and third membrane modules were enriched in light compounds (C₂⁻). Each of these two streams can be considered as a process product. Of course, it is also possible to form a single process product by mixing these two streams. A liquid stream exiting the reboiler at bottom of the distillation column was rich in C₃⁺ compounds, which formed the liquid LPG product. An amount of C₁ and C₂ compounds (especially C₂) in the produced LPG liquid was controlled by adjusting the temperature of the reboiler at bottom of the distillation column. Surface of the second membrane module was a factor which controlled an amount of C₃⁺ recovery. Furthermore, the energy needed in the reboiler at bottom of the distillation column was supplied from discharge stream of the feed compression unit, leading to minimizing total thermal energy consumption of an exemplary process. Hence, heat load of an after-cooler exchanger of the feed compression unit was reduced by heat absorbed in the reboiler of the distillation column.

Examples presented in Table 2 shows that from a feed stream with a predetermined composition, three liquid LPG products with different compositions may be produced. Such flexibility in composition of final product provides a capability of producing customized final product according to the request of a customer which is an important advantage for an LPG recovery process using an exemplary process disclosed here.

Cases of 1, 2, and 3 presented in Table 2 show three different conditions to produce three different liquid LPG products in which composition of C₂ is 0.5, 5, and 10 mol %, respectively. It is worth mentioning that vapor pressure of LPG product is largely affected by presence of C₂ due to its low molecular weight and consequently high volatility. Meanwhile, as data of Table 2 shows, concentration of C₁ in all three products is nearly negligible. Based on the content of C₂, LPG product of case 1 has the lowest vapor pressures and LPG product of case 3 has the highest vapor pressure. Therefore, product produced in case 1 is a product with higher quality compared to those presented in cases 2 and 3.

Furthermore, results of Table 2 shows that producing a high quality LPG product with low content of C₂ results in reduction of recovery of C₃⁺. Albeit, it should be noted that compression requirements of these three cases are nearly the same and reducing the content of C₂ in the final product directly affects and reduces recovery of an exemplary plant. As it may be seen, reduction in recovery rate in operation conditions may be realized through tracking an increase in mass of C₁-rich stream and C₂-rich stream.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments. This is for purposes of streamlining the disclosure, and is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments have been described, the description is intended to be exemplary, rather than limiting and it will be apparent to those of ordinary skill in the art that many more embodiments and embodiments are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

What is claimed is:

1. A process for recovery of C₃⁺ hydrocarbons form gas streams containing C₁, C₂ and C₃⁺, the process comprising:
compressing a feed gas containing C₁, C₂ and C₃⁺ to a pressure of 15 bar;
adjusting temperature of the compressed feed gas to a temperature of 30° C.;
feeding the compressed feed gas to a first membrane module;
retrieving a permeate stream comprising a first C₃⁺-rich stream from the first membrane module, the first C₃⁺-rich stream comprising a higher content of C₃⁺ than the feed gas;
retrieving a retentate stream comprising a first C₁- and C₂-rich stream from the first membrane module, the first C₁- and C₂-rich stream comprising a higher content of C₁ and C₂ than the feed gas;
recycling a remaining amount of C₃⁺ in the first C₁- and C₂-rich stream by enriching the C₁- and C₂-rich stream in a second membrane module, comprising:
feeding the first C₁- and C₂-rich stream to the second membrane module;
retrieving a retentate stream comprising a second C₁- and C₂-rich stream from the second membrane module, the second C₁- and C₂-rich stream comprising a higher content of C₁ and C₂ than the first C₁- and C₂-rich stream;
extracting a second C₃⁺-rich stream from the second membrane module, the second C₃⁺-rich stream comprising a permeate stream from the second membrane module; and
recycling the second C₃⁺-rich stream to the first membrane module by mixing the second C₃⁺-rich stream with the feed gas;
compressing the first C₃⁺-rich stream to a pressure of 15 bar;
forming a two-phase stream by cooling the compressed first C₃⁺-rich stream to a temperature of 30° C.;
separating the two-phase stream to a liquid phase of the two-phase stream and a vapor phase of the two-phase stream in a separator unit at a constant temperature of 30° C., the liquid phase of the two-phase stream forming a separator-liquid C₃⁺-rich stream comprising a higher content of C₃⁺ than the first C₃⁺-rich stream;
removing volatile compounds from the separator-liquid C₃⁺-rich stream, comprising:
feeding the separator-liquid C₃⁺-rich stream to a distillation column;
performing a distillation process in the distillation column, comprising:
withdrawing a liquid stream from bottom of the distillation column;
generating a vapor flow by heating the withdrawn liquid stream in a reboiler unit to a temperature in a range of 55° C. to 75° C. using the compressed feed gas as a thermal energy source, the vapor flow comprising the volatile compounds of the separator-liquid C₃⁺-rich stream; and
returning the generated vapor flow to the distillation column; and
withdrawing a bottoms C₃⁺-rich stream comprising a liquid flow from the reboiler unit, the liquid flow comprising non-volatile compounds of the separator-liquid C₃⁺-rich stream with a higher content of C₃⁺ than the separator-liquid C₃⁺-rich stream; and
recovering a C₃⁺ content remaining in the vapor phase of the two-phase stream and a vapor outlet from top of the distillation column, comprising:
forming an overhead stream by mixing the vapor phase of the two-phase stream and the vapor outlet from top of the distillation column;
feeding the overhead stream to a third membrane module; and
recycling a permeate stream from the third membrane module to the first membrane module by mixing the permeate stream from the third membrane module with the feed gas.

2. The process of claim 1, wherein adjusting the temperature of the compressed feed gas comprises:
cooling the compressed feed gas stream in the reboiler unit by transferring thermal energy of the compressed feed gas to the withdrawn liquid stream in the reboiler unit via boiling the withdrawn liquid stream in the reboiler unit using thermal energy of the compressed feed gas by passing the compressed feed gas through a hot side of the reboiler unit and passing the withdrawn liquid stream through a cold side of the reboiler unit; and
adjusting the temperature of the compressed feed gas at a temperature in the range of 25° C. to 35° C. by further cooling the compressed feed gas in a heat exchanger unit using a coolant fluid.

3. The process of claim 1, wherein the process is done iteratively in a cycle up to obtain a content of C₂ in a range of 0.5 to 10 mol. % in the bottoms C₃⁺-rich stream withdrawn from the reboiler unit.

4. The process of claim 1, further comprising forming a C₁- and C₂-rich product stream, comprising:
retrieving a retentate stream comprising a third C₁- and C₂-rich stream from the third membrane module, the third C₁- and C₂-rich stream comprising a higher content of C₁ and C₂ than the overhead stream; and
obtaining the C₁- and C₂-rich product stream by mixing the second C₁- and C₂-rich stream and the third C₁- and C₂-rich stream.

5. A process for recovery of C₃⁺ hydrocarbons form gas streams containing C₁, C₂ and C₃⁺, the process comprising:
compressing a feed gas containing C₁, C₂ and C₃⁺ to a pressure in a range of 12 bar to 18 bar;
adjusting a temperature of the compressed feed gas to a temperature in a range of 25° C. to 35° C.;
forming a first C₃⁺-rich stream with a higher content of C₃⁺ than the feed gas by passing the compressed feed gas through a first membrane module, passing the compressed feed gas through the first membrane module comprising:
feeding the compressed feed gas to the first membrane module;
retrieving a permeate stream comprising the first C₃⁺-rich stream from the first membrane module; and
retrieving a retentate stream comprising a first C₁- and C₂-rich stream from the first membrane module, the first C₁- and C₂-rich stream comprising a higher content of C₁ and C₂ than the feed gas;
recycling a remaining amount of C₃⁺ in the first C₁- and C₂-rich stream by enriching the first C₁- and C₂-rich stream in a second membrane module, comprising:
feeding the first C₁- and C₂-rich stream to the second membrane module;
retrieving a retentate stream comprising a second C₁- and C₂-rich stream from the second membrane module, the second C₁- and C₂-rich stream comprising a higher content of C₁ and C₂ than the first C₁- and C₂-rich stream;
extracting a second C₃⁺-rich stream from the first C₁- and C₂-rich stream by retrieving a permeate stream from the second membrane module; and
recycling the second C₃⁺-rich stream to the first membrane module;
compressing the first C₃⁺-rich stream to a pressure in a range of 12 bar to 18 bar;
forming a two-phase stream by cooling the compressed first C₃⁺-rich stream to a temperature in a range of 25° C. to 35° C., the two-phase stream comprises a vapor-liquid C₃⁺-rich stream;
separating the two-phase stream to a separator-liquid C₃⁺-rich stream and a vapor phase in a separator unit at a constant temperature in a range of 25° C. to 35° C., the separator-liquid C₃⁺-rich stream comprising the liquid phase of the two-phase stream with a higher content of C₃⁺ than the first C₃⁺-rich stream; and
forming a bottoms C₃⁺-rich stream with a higher content of C₃⁺ than the separator-liquid C₃⁺-rich stream by removing volatile compounds from the separator-liquid C₃⁺-rich stream, removing volatile compounds from the separator-liquid C₃⁺-rich stream comprising:
feeding the separator-liquid C₃⁺-rich stream to a distillation column;
performing a distillation process in the distillation column, comprising:
withdrawing a liquid stream from bottom of the distillation column;
generating a vapor flow by heating the withdrawn liquid stream in a reboiler unit to a temperature in a range of 55° C. to 75° C., the vapor flow comprising the volatile compounds of the separator-liquid C₃⁺-rich stream; and
returning the generated vapor flow to the distillation column; and
obtaining the bottoms C₃⁺-rich stream by withdrawing a liquid flow from the reboiler unit, the liquid flow comprising non-volatile compounds of the separator-liquid C₃⁺-rich stream with a higher content of C₃⁺ than the separator-liquid C₃⁺-rich stream.

6. The process of claim 5, wherein adjusting the temperature of the compressed feed gas comprises:
primary cooling the compressed feed gas stream in the reboiler unit by transferring thermal energy of the compressed feed gas to the withdrawn liquid stream in the reboiler unit via passing the compressed feed gas through a hot side of the reboiler unit and passing the withdrawn liquid stream through a cold side of the reboiler unit; and
adjusting the temperature of the compressed feed gas at a temperature in the range of 25° C. to 35° C. by further cooling the compressed feed gas in a heat exchanger unit using a coolant fluid.

7. The process of claim 5, wherein recycling the second C₃⁺-rich stream to the first membrane module comprises:
compressing the second C₃⁺-rich stream to a pressure in a range of 12 bar to 18 bar;
adjusting a temperature of the compressed second C₃⁺-rich stream to a temperature in a range of 25° C. to 35° C.; and
feeding the compressed second C₃⁺-rich stream to the first membrane module.

8. The process of claim 5, wherein recycling the second C₃⁺-rich stream to the first membrane module comprises mixing the second C₃⁺-rich stream with the feed gas before compressing the feed gas.

9. The process of claim 5, wherein the process is done iteratively in a cycle up to obtain a content of C₂ in a range of 0.5 to 10 mol. % in the bottoms C₃⁺-rich stream withdrawn from the reboiler unit.

10. The process of claim 5, wherein forming the two-phase stream comprises:
passing the compressed first C₃⁺-rich stream through a heat exchanger unit; and
reducing the temperature of the compressed first C₃⁺-rich stream to the temperature in the range of 25° C. to 35° C. in the heat exchanger unit using a coolant fluid.

11. The process of claim 5, wherein separating the two-phase stream to the separator-liquid C₃⁺-rich stream and the vapor phase in the separator unit comprises:
feeding the two-phase stream to the separator unit;
withdrawing the separator-liquid C₃⁺-rich stream comprising a liquid phase of the two-phase stream from bottom of the separator unit; and
withdrawing the vapor phase of the two-phase stream from top of the separator unit, the vapor phase of the two-phase stream comprising a higher content of C₁ and C₂ than the first C₃⁺-rich stream,
wherein a temperature of the separator unit is constant at a temperature in the range of 25° C. to 35° C. equal to a temperature of the two-phase stream.

12. The process of claim 5, further comprising recovering a C₃⁺ content remaining in the vapor phase of the two-phase stream and a vapor outlet from top of the distillation column, comprising:
forming an overhead stream by mixing the vapor phase of the two-phase stream and the vapor outlet from top of the distillation column;
feeding the overhead stream to a third membrane module; and
recycling a permeate stream from the third membrane module to the first membrane module, the permeate stream from the third membrane module comprising a higher content of C₃⁺ than each of the vapor phase of the two-phase stream and the vapor outlet from top of the distillation column.

13. The process of claim 12, wherein recycling the permeate stream from the third membrane module to the first membrane module comprises:
compressing the permeate stream from the third membrane module to a pressure in a range of 12 bar to 18 bar;
adjusting a temperature of the compressed permeate stream from the third membrane module to a temperature in a range of 25° C. to 35° C.; and
feeding the compressed permeate stream from the third membrane module to the first membrane module.

14. The process of claim 12, wherein recycling the permeate stream from the third membrane module to the first membrane module comprises mixing the permeate stream from the third membrane module with the feed gas before compressing the feed gas.

15. The process of claim 12, further comprising retrieving a retentate stream from the third membrane module comprising a third C₁- and C₂-rich stream, the third C₁- and C₂-rich stream comprising a higher content of C₁ and C₂ than the overhead stream.

16. The process of claim 15, further comprising forming a C₁- and C₂ rich product stream by mixing the second C₁- and C₂-rich stream and the third C₁- and C₂-rich stream.

17. The process of claim 12, wherein feeding the overhead stream to the third membrane module comprises feeding the overhead stream to a set of rubbery polymer membranes placed sequentially after each other.

18. The process of claim 5, wherein passing the compressed feed gas through the first membrane module comprises passing the compressed feed gas stream through a set of rubbery polymer membranes placed sequentially after each other.

19. The process of claim 5, wherein feeding the first C₁- and C₂-rich stream to the second membrane module comprises feeding the C₁- and C₂ rich stream to a set of rubbery polymer membranes placed sequentially after each other.
